(19) United States
(12) Patent Application Publication
(10) Pub. No.: US 2002/0077757 A1
(43) Pub. Date: Jun. 20, 2002

(54) Chemistry resource database

(75) Inventors: Barry A. Bunin, Santa Clara, CA (US); Stephan C. Schurer, Mountain View, CA (US); Steve M. Muskal, Carlsbad, CA (US)

Correspondence Address: BEYER WEAVER & THOMAS LLP, P.O. BOX 778, BERKELEY, CA, 94704-0778, US

(73) Assignee: Libraria, Inc.

(21) Appl. No.: 09/996,635

(22) Filed: Nov. 28, 2001

Related U.S. Application Data
(63) Continuation-in-part of application No. 09/825,135, filed on Apr. 2, 2001.
(60) Provisional application No. 60/194,338, filed on Apr. 3, 2000.
(60) Provisional application No. 60/198,482, filed on Apr. 18, 2000.

(51) Int. Cl. G06F 19/00

(52) U.S. Cl. 702/32

(57) ABSTRACT

Reaction steps are organized as belonging to particular reaction protocols within a database. Each reaction may represent a discrete step in a multi-step protocol for making a final product from a starting reactant. To populate the database, a system receives information separately from a plurality of references (e.g., literature articles, patent publications, etc.). Such information typically includes descriptions of reaction steps presented in the references (e.g., detailed recipes for performing the reaction steps). Alternatively, or in addition, the methodology includes identifying at least one protocol specified in the reference, which protocol comprises two or more reaction steps, and then specifying that the two or more reaction steps belong to the protocol.

### CROSS-REFERENCE TO RELATED APPLICATIONS

This application is a continuation-in-part of U.S. patent application Ser. No. 09/825,135, filed Apr. 2, 2001, naming B. Bunin as inventor, and titled “CHEMISTRY RESOURCE DATABASE.” This application is related to U.S. Provisional Patent Application No. 60/194,338 filed Apr., 3, 2000 and titled “System and Method for Obtaining Disease Target Solutions.” This application is also related to U.S. Provisional Application No. 60/198,482 filed Apr. 18, 2000 and titled “Tying an Evolving Database of Chemical Information to Flexible Services.”

### FIELD OF THE INVENTION

The invention relates to database technology. More specifically the invention relates to methods for using and populating a chemistry resource database organized by chemical reaction and protocol.

### BACKGROUND OF THE INVENTION

The modem organic chemist has numerous software tools at her disposal. These include tools for predicting activity from chemical structure (termed “structure activity relationship” tools or SAR tools), tools for ordering commercially available reagents, and databases for storing vast quantities of chemical information and including links to literature. Many of these tools have appeared recently in order to take advantage of new electronic infrastructure and electronic commerce. Others have appeared because the computational power now exists to solve previously intractable problems (or reasonably approximate a solution to these problems).

Some of the most widely used on-line databases provide electronically indexed data that previously appeared in textual research tools on library shelves (e.g., Beilstein, Chemical Abstracts, and the like). While such databases include various modem electronic features, they are at their heart collections of traditional chemical information reformatted for electronic databases. These existing databases are essentially lists indexing the literature with information to help the chemist decide if she wishes to obtain a particular article. As such they are not optimized to facilitate the research of a modem chemist.

One set of problems that cannot be easily addressed using current chemical software pertains to constraints on the range of reaction conditions available to a chemist. Another important issue is access to detailed information on reactivity and chemical pathways in a database format, especially for high-throughput chemistry. Often the inherent features of a laboratory facility or piece of chemical instrumentation will constrain the range of reaction conditions available to the chemist. A good example is found in combinatorial chemistry or parallel synthesis laboratory equipment. Commonly, such apparatus is unable to provide a wide range of reaction conditions for chemical synthesis. This is because such apparatus must be designed to perform many chemical syntheses simultaneously and on very small reaction scale. Hence the apparatus is quite intricate. This can make it difficult to provide variable heating and cooling, inert atmospheres, highly reactive reagent delivery, etc. Furthermore many interesting molecules are unstable to heat and/or light. If a chemist uses a software tool to suggest compounds having potentially useful activities, she would like to know whether such compounds are stable (and can in fact be synthesized) under synthesis conditions available to her. Currently, no tool provides such information. Part of the problem is that current databases do not effectively organize chemical information based on chemical reaction conditions or reaction chemistries.

Another potential problem arises when a chemist undertakes a new line of research and needs to use unfamiliar synthesis chemistries. In such cases, she would probably like to start with compounds that are relatively easy to synthesize. Often within a class of precursors that undergo a particular reaction, some members will undergo the reaction much more reliably than others. The chemist new to this field will wish to know which such precursors are most reliable. Similarly, an experienced chemist often comes upon reactions that intuitively should work, but in practice do not. Reaction chemistries coupled with reliability ratings can provide a powerful tool to the synthetic chemist, saving time and money which would otherwise be wasted on fruitless experiments. Unfortunately current software tools fail to conveniently provide reliability data to the chemist.

Yet another problem confronts chemists attempting to generate diverse libraries of compounds for drug discovery or other product discovery research. The literature and databases are limited in their ability to suggest the full potential of a discovery path. Often a chemist will understand that some portion of a compound (a compound fragment) is at least partially responsible for a desired activity. Such knowledge may derive from pharmacophore research, for example. In the discovery process, the chemist will wish to generate a library of compounds possessing the fragment of interest or some variant thereof. To do so, she may use combinatorial chemistry to generate a large library of compounds. In combinatorial chemistry multiple precursors, each having the desired fragment, are further elaborated through one or more syntheses. The resulting library of compounds is diverse but limited by the reaction chemistries either known to the chemist or found by searching through conventional databases. Greater diversity could be achieved if additional variations on reaction chemistry, not necessarily in the literature, were suggested to the chemist. In particular, it would be useful to have a relational database of the various chemical pathways possible from any particular functional group in the database. The capability to explore the diverse chemical pathways accessible from any particular functional group does not exist in current software products because they were not designed to enable this core capability in the underlying molecular database architecture.

The problems resulting from the above software limitations are compounded because the pace of chemical research is ever increasing. New synthetic procedures are developed, tested, and retested daily. New insights into organic chemistry, structural biology, and drug discovery occur frequently. It is a mighty challenge for electronic repositories of chemical information to keep pace with these developments.

What are needed are improved software tools for the research chemist that facilitate chemical research.

### SUMMARY OF THE INVENTION

The present invention addresses these needs by providing improved software tools that employ databases and associated systems for storing, manipulating, and investigating chemical information organized by reaction chemistries. At least some reaction chemistries are organized as belonging to particular reaction protocols within the database. Each reaction represents a discrete step in a multi-step protocol for making a final product from a starting reactant. The invention provides a convenient methodology for populating a database of chemical information. Such methodology includes receiving information separately from a plurality of references (e.g., literature articles, patent publications, laboratory notebooks, etc.). Such information typically includes descriptions of reaction steps presented in the references (e.g., detailed recipes for performing the reaction steps). Alternatively, or in addition, the methodology includes identifying at least one protocol specified in the reference, which protocol comprises one or more reaction steps, and then specifying that the one or more reaction steps belong to the protocol.

The tools of this invention may allow users to apply filters such as chemical reaction condition filters or starting material filters that only return reactions or protocols that can be performed using specified reaction conditions and/or starting materials. Further, the software tools may automatically suggest/generate diverse reaction sets for particular precursors, classes of precursors, or different reaction chemistries. This is accomplished by automatically generating a group of reaction chemistries for a particular precursor or class of precursors. This is enabled by marking up (or tagging) the information according to reaction group and reaction condition when putting it into the database to allow the patterns to emerge. Some of the reactions and/or products may be produced without reliance on reactions and products reported in available references.

Thus, one aspect of the invention is a method of populating a database of chemical information. Such methods may be characterized by the following sequence: (a) receiving a plurality of references containing chemical content meeting specified criteria; and (b) for each reference identified in (a): (i) entering descriptive information about the reference; (ii) identifying one or more reaction steps specified in the reference; and (iii) for each reaction step identified in (ii), entering a description of the procedure for performing the reaction.

In the invention, some references are characterized as having protocols that may include two or more reaction steps. Thus, another aspect of the invention pertains to a method of populating a database of chemical information. Such methods may be characterized by the following sequence: (a) receiving a plurality of references containing chemical content meeting specified criteria; and (b) for each reference identified in (a): (i) entering descriptive information about the reference; (ii) identifying at least one protocol specified in the reference, which protocol comprises two or more reaction steps; and (iii) specifying that the two or more reaction steps belong to said protocol in a manner that links the two or more reaction steps to one another within the protocol.

Preferably methods of the invention will include entering structures of one or more of a reactant and a product of the reaction step; and for each reference identified, further identifying concepts that pertain to a chemical ontology and associating said reference with corresponding categories of the chemical ontology. Preferably the entered structures are provided in a standard chemical structural format. A structure of a reagent or solvent used in the reaction step may also be entered. Preferably the chemical ontology is defined at one or more of the following levels: a reference level, a protocol level, and a reaction level.

References may include one or more of a literature article, a patent document, unpublished experimental results, publications and the like. Specified criteria may include disclosure of an organic molecule synthesis, which may include syntheses of a library of organic molecules. Additionally, methods may include entering one or more leading references that comprise literature references or patent documents describing reactants discussed in the reference or work on which the reference is based.

Descriptive information may include at least one of an author of the reference, an inventor of concepts within the reference, contact information for an author or inventor, an abstract, and the like. Preferably the descriptive information is entered in specific fields corresponding to attributes in records of the database.

Another aspect of the invention pertains to computer program products including machine-readable media on which are stored program instructions for implementing at least some portion of the methods described above. Any of the methods of this invention may be represented, in whole or in part, as program instructions that can be provided on such computer readable media. In addition, the invention pertains to various combinations of data and data structures generated and/or used as described herein.

These and other features and advantages of the present invention will be described in more detail below with reference to the associated figures.

### BRIEF DESCRIPTION OF THE DRAWINGS

The following detailed description can be more fully understood when considered in conjunction with the drawings in which:

FIG. 1A shows aspects of how data records are organized according to one embodiment of the invention.

FIG. 1B shows aspects of how references are organized according to another embodiment of the invention.

FIG. 1C shows aspects of how references are organized according to another embodiment of the invention.

FIG. 1D shows aspects of how references are organized according to yet another embodiment of the invention.

FIGS. 2A-C depict flow aspects of a method for populating a database in one embodiment of the invention.

FIG. 2D the various formats in which a chemical structure is depicted, in accordance with one embodiment of this invention.

FIGS. 2E-H are exemplary screen shots of a GUI (graphical user interface) for populating a database in accordance with the invention.

FIG. 3 is a simplified block diagram of a computer system that may be used to implement various aspects of the invention.

### DETAILED DESCRIPTION OF THE PREFERRED EMBODIMENTS

In the following detailed description of the present invention, numerous specific embodiments are set forth in order to provide a thorough understanding of the invention. However, as will be apparent to those skilled in the art, the present invention may be practiced without these specific details or by using alternate elements or processes. For example, the methods of populating a database described herein employ reaction steps obtained from “references.” However, the invention could equally well be applied to methods that employ internally generated reaction information that is not recorded in the form of a reference. In some descriptions herein, well-known processes, procedures, and components have not been described in detail so as not to unnecessarily obscure aspects of the present invention.

Introduction

The present invention provides databases and associated systems for storing, manipulating, and investigating chemical information organized by reaction chemistry. Methods of the invention are embodied in software tools for populating and using databases. Data used to populate databases may be selected and organized from the chemist's perspective. For example, the chemical reaction information resident in a database may be organized at the level of reaction chemistries. In addition, the chemical information can be organized at the level of a protocol employing specific reaction chemistries and/or a reference presenting the protocols or reactions. In many embodiments, specialized software filters are available for limiting the range of chemical information provided from the databases via queries. The software used to populate and search databases of this invention typically includes designated fields for entering the specialized information needed to populate, search or filter database data.

Definitions

To clearly describe certain embodiments of the invention, some terms used herein are defined as follows. These definitions are provided to assist the reader in understanding the concepts exemplified in the specification and the definitions do not necessarily limit the scope of this invention.

Reaction

A “reaction” is a fundamental chemical transformation of one or more reactants to one or more products. As used herein “reaction” and “reaction step” are synonymous. Examples of reactions include condensation reactions (e.g., esterification, amidation, imine formation), carbon-carbon couplings (e.g., Suzuki, Wittig, Heck), and reduction reactions (e.g., nitro reductions, hydrogenations, reductive amination). Multiple reactions may be concatenated to produce a “protocol” or synthetic pathway to a final product. To succeed, a reaction may require certain reaction conditions. Such conditions may include a reaction temperature, a reaction time, etc. Specialized laboratory instrumentation may be required to provide the needed reaction conditions. Commonly, a reaction will employ one or more reagents and/or solvents.

Protocol

A protocol is a group of chemical reactions, typically performed sequentially, to carry out an encompassing transformation from a starting reactant or reactants to a final product or products. The terms “reaction scheme” and “synthetic pathway” are often used in the art to mean “protocol,” as that term is used herein. A protocol may include not only its constituent reactions, but also any associated reaction conditions used to carry out each of the reactions or reaction steps. An example of a multi-step protocol is a synthesis of a particular tripeptide using sequential two reactions. The first reaction couples a first amino acid to a second amino acid to form a dipeptide. The second reaction couples the dipeptide to a third amino acid to form the tripeptide.

Reference

A reference is document or other medium containing pertinent information. In the context of this invention, the pertinent information is usually chemical information. This concept includes traditional published literature articles, published and unpublished patent documents (patent applications and issued patents), unpublished experimental results, books, monographs, abstracts, and the like.

Reactant

This term encompasses the compounds used in any particular reaction that are transformed or converted by the reaction to a product. Specifically for this invention, reactants are those molecules that are modified in some way to become part of or are incorporated into the product molecule or molecules of a reaction, and thus are not “spectators” in the reaction.

Reagent

Reagents are those compounds used in a reaction that ultimately do not end up as part of the product molecules. Such molecules include solvents, catalysts, and other reaction mediators. Reagents are, overall, spectators in the reaction. Although they may be intimately involved with the reactants during the reaction, generally neither they nor subsets of their molecular structure become incorporated into the product's molecular structure. Generally solution phase reactions refer to homogeneous reactions; however, some solution phase reactions referred to are heterogeneous reactions. A reagent used in a solution phase reaction may mediate the reaction while immobilized on a solid phase support or may itself exist in the solid phase. For example an isocyanate scavenger bound to an inert polymer resin may be used to trap excess amine in a solution phase reaction or a catalyst solid may itself remain as a solid in a solution phase reaction. For solid phase reactions, generally one reactant is immobilized on a solid support medium, and other reactants and “reagents” used in the reaction are in the liquid phase. For example, a “scaffold” or “template” molecule is immobilized on a solid support. A reaction with this molecule is then performed in a particular solvent (reagent) with one or more reactants, parts of which become integrated into the scaffold or template molecule to become part of a product molecule, itself still bound to the solid support. The product molecule is then freed from the solid support using a “cleaving reagent.”

Solvent

A solvent is generally the liquid medium in which a reaction takes place. For solid-phase reactions, a solvent is the liquid medium in which solid phase supported reactants are suspended and reagents are dissolved. For solution phase reactions, a solvent is the liquid medium in which reactants are dissolved, but solid phase reagents are suspended. There are cases in which a compound serves multiple roles, for example as both solvent and reactant or both solvent and reagent.

Reaction Condition

Reaction condition refers to parameters under which a reaction takes place, for example, time, temperature, pressure, radiation, solvents or reagents used.

Laboratory Instrumentation or Equipment

These terms refer to the hardware used to carry out reactions; i.e. for traditional synthesis any glassware, heating devices, pressure vessels etc. and for combinatorial or parallel synthesis any hardware used to perform multiple reactions in parallel. Sometimes this term is used to define the minimal amount of hardware necessary to carry out a reaction; i.e., hardware that does not include peripheral devices or equipment not crucial to carry out a reaction. In this context, the term might not encompass a particular robotic device, for example.

Procedure

Generally, a procedure is a “recipe” for a particular chemical transformation. More specifically, a procedure refers to the detailed methods used by the chemist to carry out a reaction. Typically a procedure refers to a detailed textual account of the sequence of events, reagents, reactants, laboratory instrumentation or equipment, and reaction conditions used by the chemist to carry out a particular reaction. A procedure then allows a chemist in a laboratory to reproduce the chemical reaction to which the procedure refers without access to other source of information regarding the reaction being carried out.

Product

Products are molecules that result from a reaction of reactants. Thus for example, a chemist using a set of reactants and using associated procedures converts the reactants into a product or set of products.

Ontology

Ontology in this application refers to the logical linkage of categories used to classify a type of chemical information such as a reference, a protocol, or a reaction. These categories are often arranged in levels of a hierarchy. For example, a reference may be categorized at a high level as pertaining to either solid-phase chemistry or solution-phase chemistry. Each of these categories may be further categorized as to the reaction type, for example condensation reaction, carbon-carbon bond forming reaction, substitution reaction, and the like. Still further, each of these categories is further categorized more definitively, for example a condensation reaction category may contain amide-forming condensations, ester-forming condensations, imine-forming condensations, and the like. Each of references, protocols, and reactions possess hierarchical components of a given ontology.

Enumeration

Often a compound or reaction is represented in a generic format. That is, for a particular compound reaction genus there may be multiple species. A generic compound (reactant or product) is represented as a core structure having one or more substituents represented generically, as for example an “R-group.” For a given R-group, there are a number of particular chemical moieties that define distinct species of the generic compound. A generic compound is “enumerated” by displaying or otherwise identifying the species comprising the genus. Each species represents a specific compound containing the core structure and a specific chemical moiety at the location of each R-group. Stated another way, enumeration refers to electronically reconstructing representations of the actual structures (reactants and products) for each species reaction. Obviously, the concept of enumeration can extend to groups of generic chemical compounds, as one might encounter in a generic representation of a reaction. In one example, a reference identifies 100 reactions that were carried out, each reaction being a species of a generic reaction. In one format, the reference may depict only the generic reaction. When enumerated, all 100 specific reactions are depicted. In some embodiments of this invention, it will be convenient to separately store in electronic format the actual R-group moieties used.

Chemical Information

This includes all information in a reference, database, or other medium that pertains to a chemical compound, a chemical reaction, collections of compounds or reactions, and the like. The chemical information may be provided in various textual, numerical, and/or structural formats. Often the information will include pertinent annotations such as reaction conditions, laboratory instrumentation, solvents, reagents, details about a reference, etc.

Filter

Generally, a filter refers to a constraint applied to a search in order to narrow or more fully define the search. In the context of this invention, a filter can be any number of search constraints that are added to a search query or applied to a set of results from such a query to further narrow or define the result in terms of the particular filter or filters applied. Filters used in embodiments of the invention can be applied at the reference, protocol, and/or reaction level as well as any fields that are contained in records of databases of the invention. Data can be searched and filtered in many combinations of ways. Examples of filters include, but are not limited to, the following: reaction condition, reaction type, library size, number of steps in a protocol, yield of reaction, molecular weight, logₚ, ADMET/PK, Lipinski rule of five, QSAR, pharmacophore, docking, binding, structure, substructure, reliability ratings, biological activity, reactivity, starting material, product, author, journal, keywords, vendor, leading references, as well as combining multiple filters in a synergistic fashion such as starting materials along reaction pathways, and the like.

Database

A set of related files or records that is created and managed by a database management system. The records may include text, images, sound, video, etc. A record is a group of related fields that store data about a subject or activity.

Knowledge Base

A Knowledge Base is a database containing domain specific content (such as, but not limited to, high-throughput chemistry for example) ideally pre-organized in a useful format. A database is a relatively static set of factual data. A Knowledge Base can be marked up and organized with increasing levels of complexity and analysis to evolve from data, to information, to knowledge incorporated within the overall software and content architecture.

### Methods of Populating Databases With Chemical Information

A part of the invention relates to methods and apparatus for populating databases with chemical information. In one embodiment, a specific hierarchy of chemical data dictates how such data is entered and organized in a database of this invention.

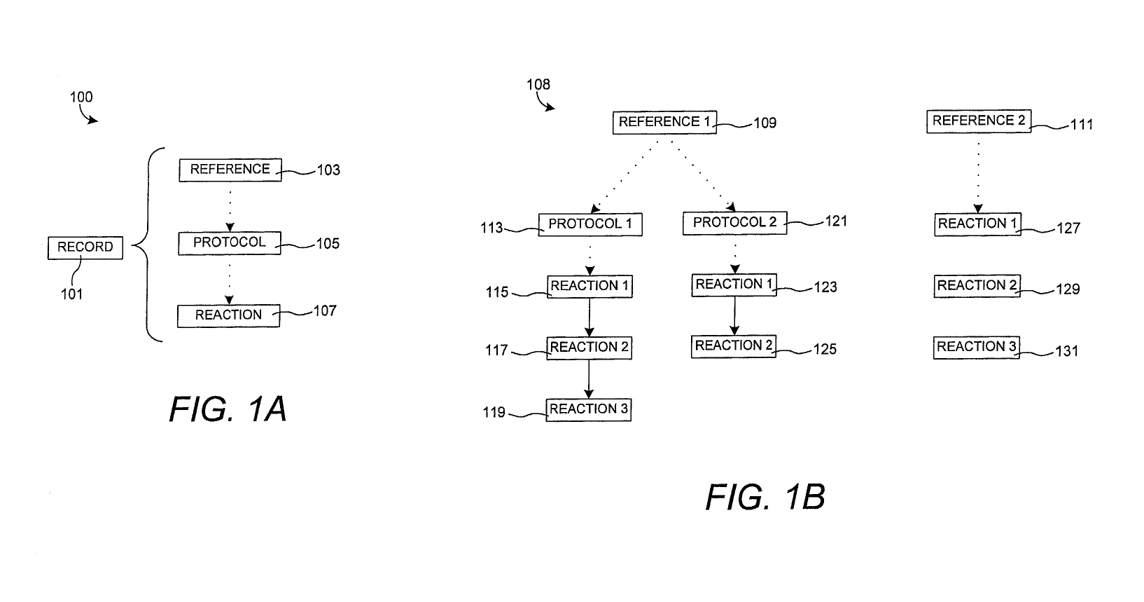

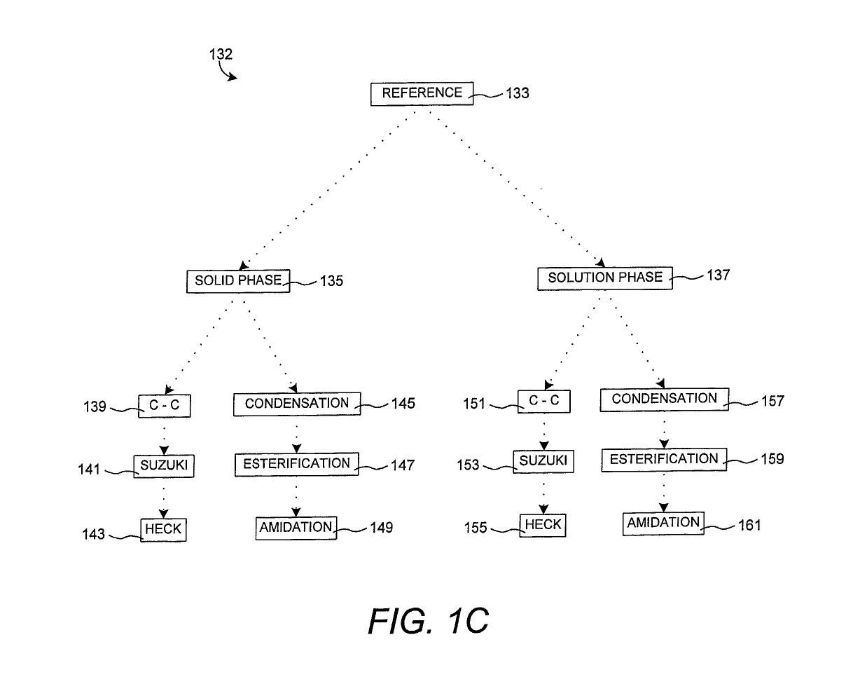

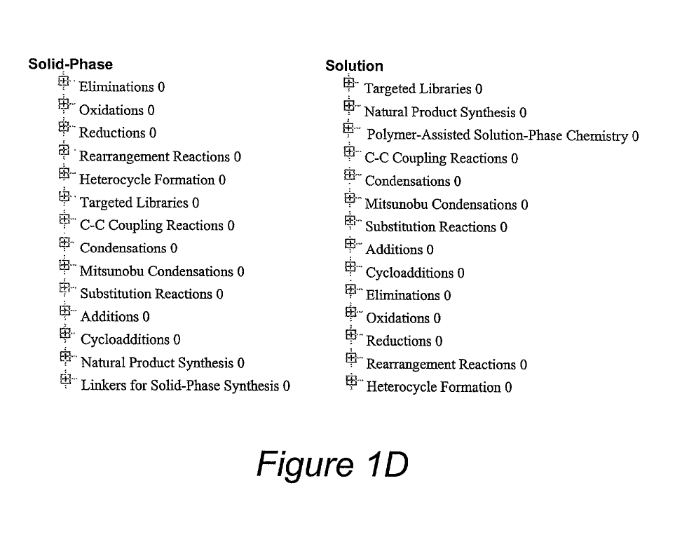

FIG. 1A shows logical categories that may be used to organize data records according to one embodiment of the invention. In this example, chemical information pertaining to a particular reference is stored in a record 101. Record 101 contains high level information 103 about a reference, such as the journal or source of the reference, title, author, volume, year, lead references, reference ontology categorization, abstract, key words, contact information, associated organizations (academic or industrial), and the like. Chemical reference information 103, may identify one or more protocols, 105. As defined above a protocol is a group of chemical reactions, typically performed sequentially, to carry out an encompassing transformation from a starting reactant or reactants to a final product or products. Thus, reference information 103 that specifies or contains protocol information 105 will also specify or contain reactions information 107 that make up protocol 105.

In a typical example, protocol information 105 includes high level information about a protocol, such as points of interest, representative examples of the protocol, and protocol ontology classifications. These will be explained further below. Each reaction of the set of reactions identified in information 107, which make up a protocol identified at 105, may have associated information, which is also stored in record 101. Such information may include procedure, reaction conditions, reaction ontology classifications, structural information about reactants, products, and reagents, and the like.

In sum, records in a database may embody a hierarchy of information that includes reference, protocol, and reactions levels. Note that the concept of a database record generally embodies all arrangements of data in which data elements (chemical information in this case) are separated from one another based on a unique identifier or combination of identifiers. In the embodiment described here, the records are delineated by one or more of reference, protocol, and reactions.

Additional hierarchical categories beyond the three depicted here may be included in certain embodiments. Examples of such additional logical elements include chemistry specific elements such as condensation reactions, amine reactants, etc., reference types such as patent documents versus published literature, country in which the reported chemistry was performed, type of research organization (academic versus corporation versus government), etc.

FIG. 1B shows a sample arrangement 108 for organizing data from two different references according to one embodiment of the invention. A first reference, 109, may contain several reactions, some of which are related to a first synthetic sequence and some that are related to a second synthetic sequence. This information is organized in a database as follows. The first synthetic sequence in the first reference, 109, is defined as a first protocol 113. The sequential reactions 115-119 that comprise the first synthetic sequence are used to define the first protocol 113. The second synthetic sequence in the first reference, 109, is defined as a second protocol 121. The sequential reactions 123-125 that comprise the second synthetic sequence are used to define the second protocol 121.

All references do not necessarily contain sequential synthetic reactions, and thus there are situations where a protocol would not be appropriate. For example in a report of synthetic methodology (e.g., a paper showing several examples of a single transformation type), a second reference, 111, may contain only non-sequentially related reaction examples 127-131. In this case the record pertaining to reference 111 would contain no protocol level information. Also, a single reference may contain both a protocol (or series of protocols) and a set of non-sequentially related reaction examples. Methods and software of the invention preferably handles references having any combination of protocols and single reaction examples, as will be discussed below.

As indicated above, each hierarchical level, i.e. reference, protocol, and reaction, may have an associated ontology to separately classify individual references, protocols, and reactions. FIG. 1C shows an example of how a reference ontology may be defined using a portion of a hierarchical tree, 132. In this case, a reference 133 may be characterized (tagged) as a solid phase reference, 135, or a solution phase reference, 137, based on whether the reactions described in the reference are implemented in a solid phase or a solution phase. In a typical case, the classification is made at the discretion of an experienced chemist, often a Ph.D. level chemist. The ontology information is provided to a database together with other information about the associated reference, protocol, or reaction. Within the ontologies, each of categories 135 and 137 can be further characterized according to the type of chemistry described therein. For example, a solid phase reference, 135, may describe carbon-carbon bond forming reactions 139, or condensation reactions 145. Each of these reaction types can further be characterized according to a particular type, for example C-C bond forming reactions 139 may be Suzuki couplings 141, or Heck reactions 143; condensations 145 may be esterifications 147, or amidations 149. Solution phase reaction category 137, can also be further categorized as depicted (see 151-161).

Some amount of discretion may be applied to categorize chemical references by ontology for optimum utility in a unified database format. Often, however, the reference will unambiguously identify the relevant ontological classifications. For example, if the bulk of subject matter of reference 133 pertained to a solid phase chemistry method, which utilized both Suzuki and Heck C-C bond forming reactions as its main theme, then the reference might be characterized as a “solid phase reference.” Its associated ontological tree would be reflected in FIG. 1C, as 133, 135, and 139-143.

Depending on the content, it may be appropriate to classify a reference as a solid phase and a solution phase reference. In this case, a reference would have two separate associated ontologies. For example, when a first user searches for solid phase references of a certain type and a second user searches for solution phase references of a certain type, the invention may retrieve the same reference for both users. This is true for example, when the reference is classified in both ways and reflects the particular query or filter applied by both the first and the second user. One example of a complete set of ontological classifications for chemical references is depicted in FIG. 1D.

As mentioned, FIG. 1C shows an example of how a reference ontology may be defined using a hierarchical tree, 132. Protocols and reactions may also be categorized using similar trees to construct protocol ontologies and reaction ontologies.

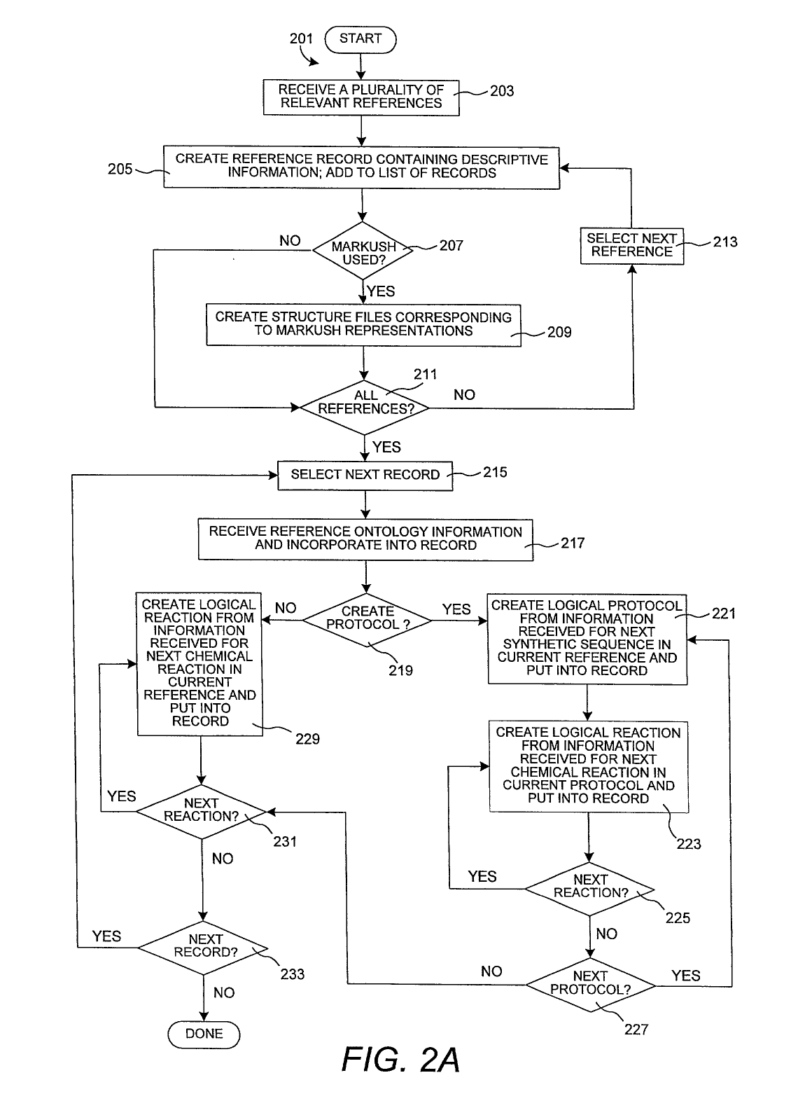

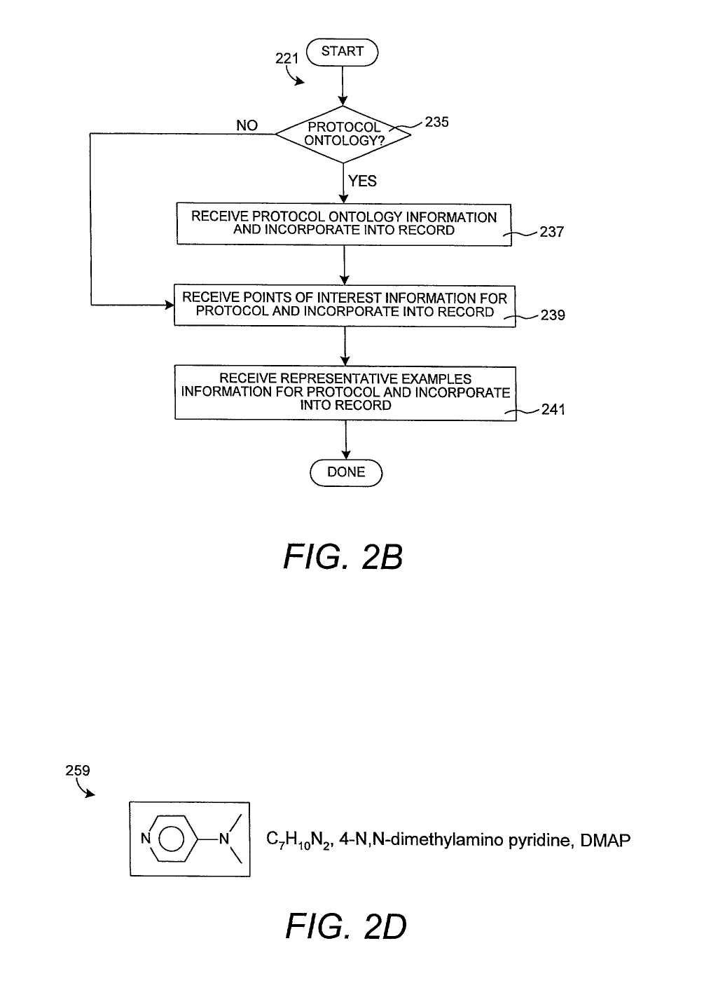

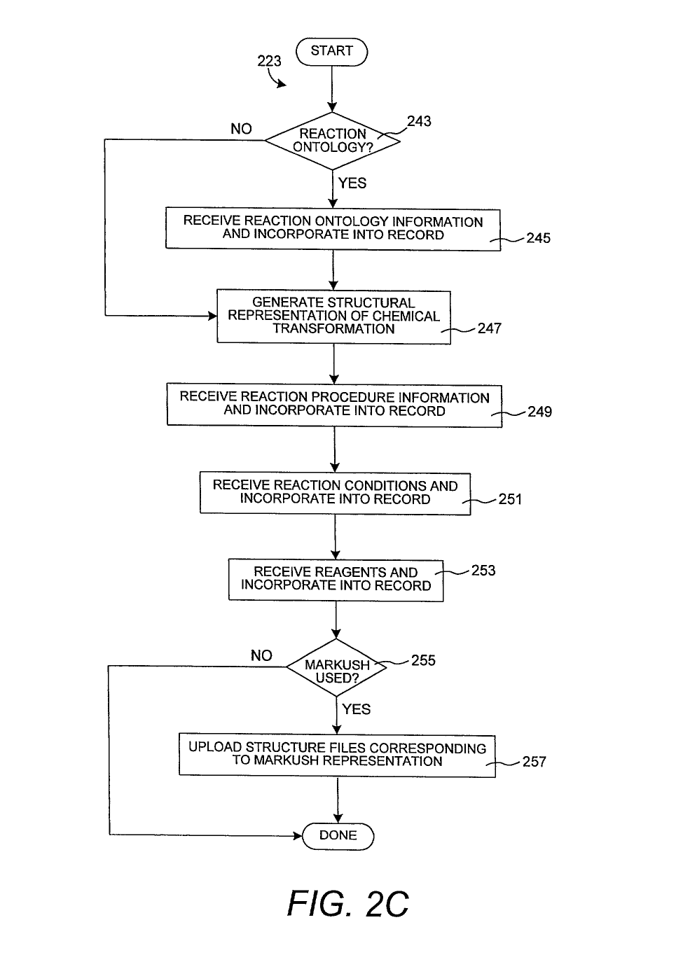

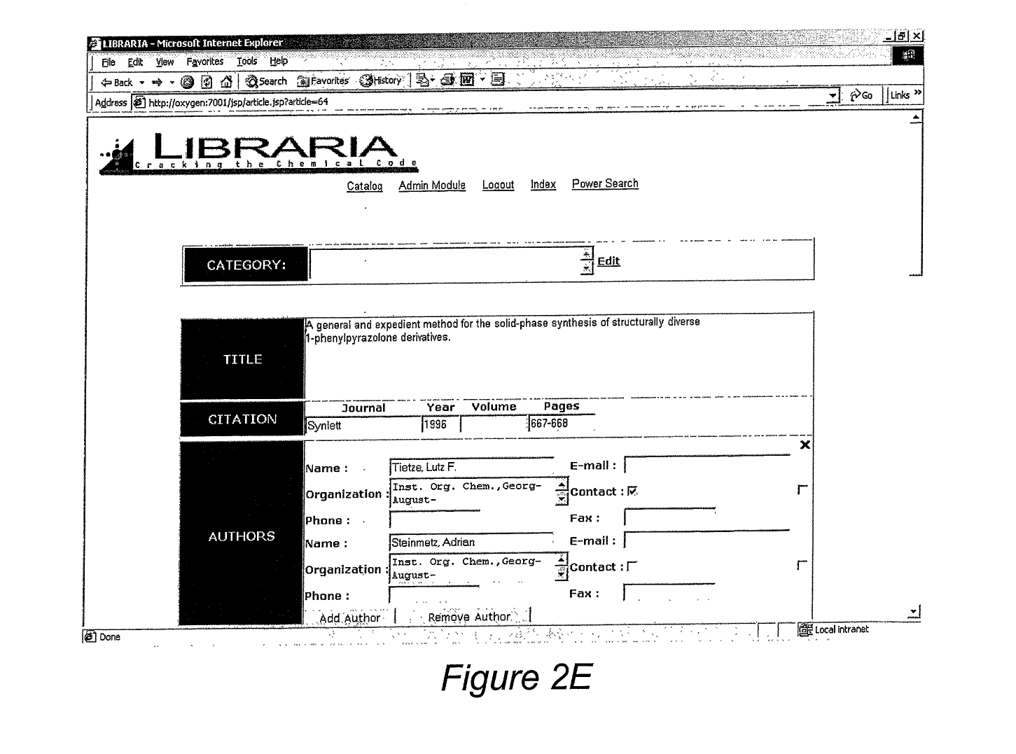

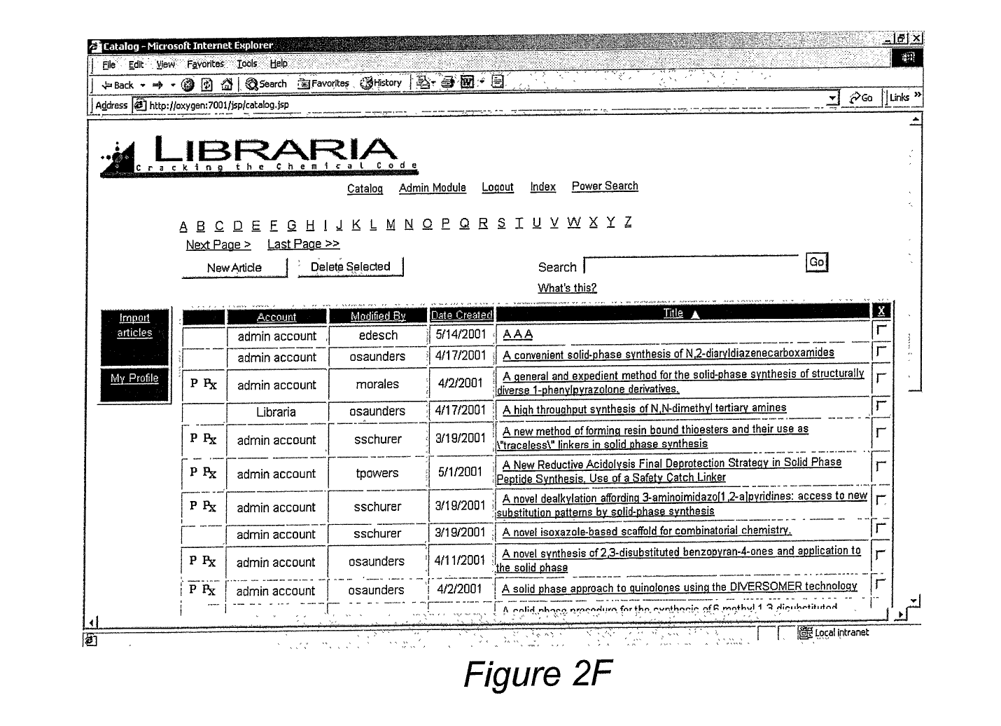

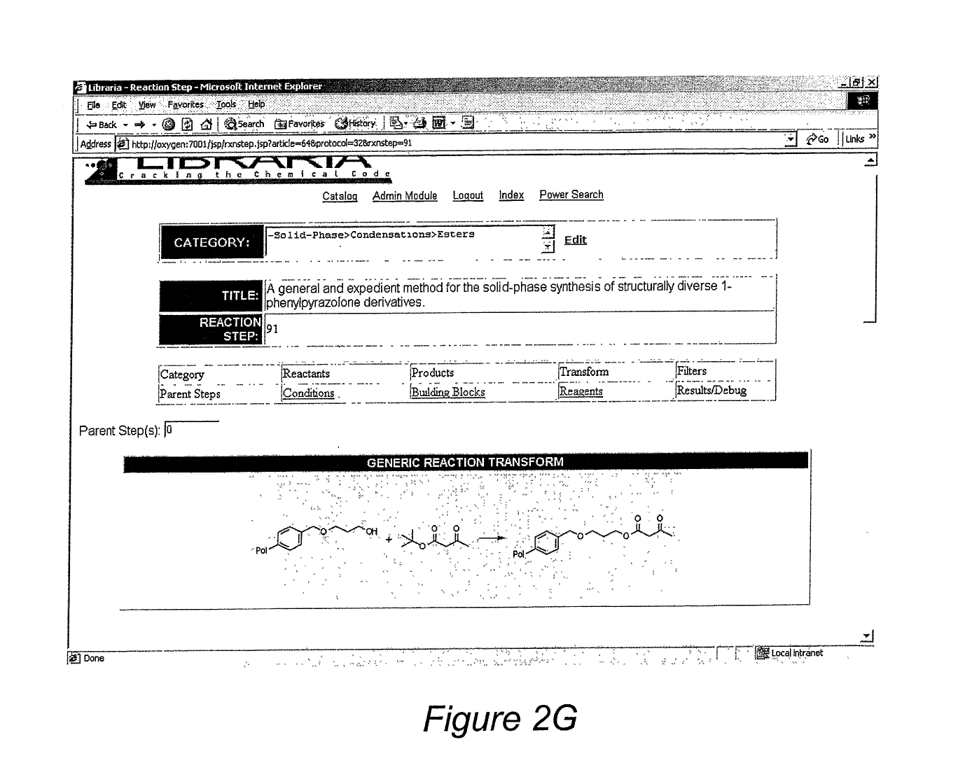

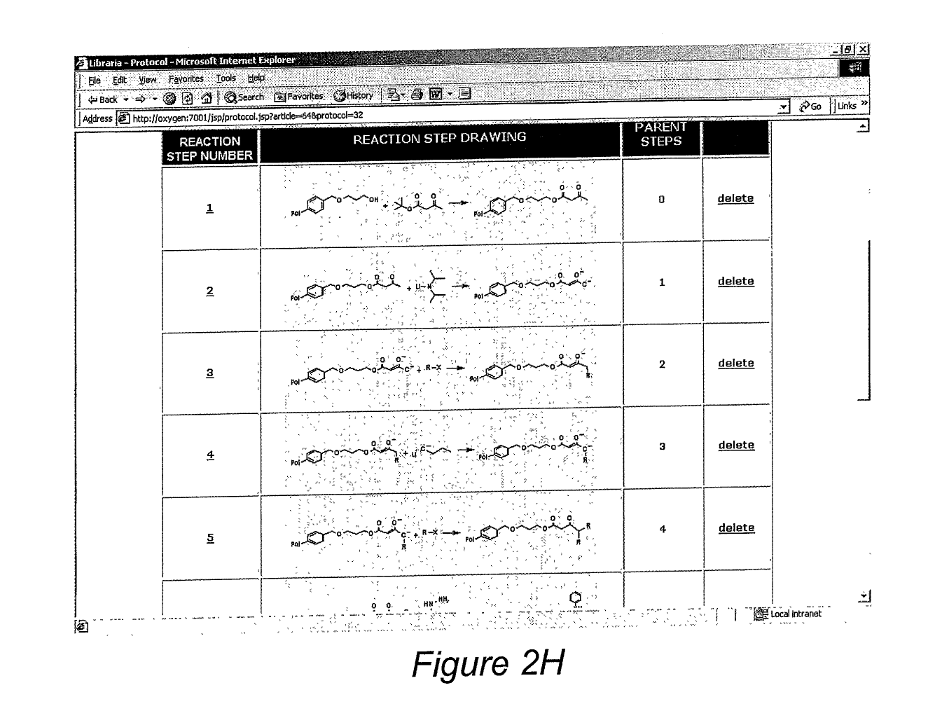

FIG. 2A is a flow chart depicting a method, 201, for populating a database in one embodiment of the invention. Software of the invention allows chemists to select and/or enter chemical information for populating a database. In this example, such a chemist might have a plurality of paper references in hand. He or she then uses software of the invention to populate the database with the information. In the following description, reference will be made to FIGS. 2E-H, which are merely examples of screen shots of one suitable web-based GUI (graphical user interface) for use as an aspect of this invention. These screen shots are meant to show an example of how the user would populate a database in accordance with the invention.

Initially, a plurality of relevant references are received, see 203. From the perspective of the software, this may simply involve allocating or freeing resources for receiving data about these references. The relevant references typically meet specified criteria such as disclosure of an organic molecule synthesis or disclosing syntheses of a library of organic molecules. Other constraints may be placed on references (e.g., the disclosed molecules must have a molecular weight of less than X). In the end, the references are selected because they contain chemical information relevant to the database being created.

After the references are “received,” they are treated in turn, with each being used to create a separate record. On an initial pass, a reference record is created for the first reference in the list. See 205. At the time the record is created, it contains descriptive information about the reference under consideration. Examples of descriptive information include an author of the reference, an inventor of concepts within the reference, contact information for an author or inventor, and an abstract. In one example, data is entered into a database via a GUI, see FIG. 2E. This record is the first in a list of records that will be used in the database. Other types of descriptive information include leading references (e.g., references on which the current reference is based or references describing how to obtain a reactant used in the disclosed reactions), starting materials, reaction conditions, intermediates, products, biological activity and detailed procedures for synthesis.

Next, a decision is made as to whether or not a Markush representation of a chemical reaction is to be used in the reference record, see 207. If so, then the software allows the user to enter or create structure files corresponding to the Markush representations that will subsequently become part of the record, see 209. The Markush representations identify the specific moieties that define member species of a Markush genus. Note that the actual Markush structure files are linked to the record later in the process flow described herein. Alternatively, the structure files can be created later in the process or the linking operation could be performed earlier.

After the first record (or any record for that matter) has been created with the descriptive information and the Markush files, if any, a decision is made as to whether all references to be entered, have now been entered. See 211. If not, then the next reference is selected (see 213) and the sequence 205-211 is repeated. Ultimately, each reference received at 203 has a corresponding record created for it. See FIG. 2F. Note that some records will have related structure files (for enumerating Markush representations), some will not. In one embodiment, reference records and associated structure files are stored separately. For example, the structure files may be stored on a server and made available to multiple different records that require the side group structures.

Once a collection of records is stored, additional information may be added to each record via a separate set of operations beginning with 215 and ending with 233. Note that while the flow chart of FIG. 2A shows information being added to records in two separated methodologies (loops 205-213 and 215-233), this need not be the case. Each reference record could be completed separately prior to starting the next reference record.

In the depicted embodiment, a new record is selected for additional input at 215. Next, reference ontology information is optionally received and incorporated into the record, see 217. In one embodiment, each record of a database has an associated reference ontology categorization. In some embodiments, protocols and reactions also have associated ontologies, with separate ontological classifications for each protocol and record.

After the reference ontology characterizing information is received, a decision is made as to whether or not a protocol is to be created. See 219. As mentioned above, a “protocol” is one logical level in a hierarchy of chemical information that may employed in databases of this invention. If the reference under consideration discloses a protocol, then a corresponding “logical protocol” for the data is created. This logical protocol will “contain” information about a specific synthetic sequence in the current reference. The relevant information, as part of a logical protocol, is incorporated into the current record. See 221.

Next, a “logical reaction” (analogous to a logical protocol) is created from information received for the next chemical reaction in the protocol and incorporated into the current record. See 223. See also FIG. 2G. As mentioned, a protocol typically contains two or more sequentially linked reactions. Each logical reaction belongs to a specific logical protocol. The member reactions of a logical protocol are linked to one another, explicitly or implicitly through the protocol.

After the current logical reaction is completed and incorporated into the current record, a decision is made as to whether or not another reaction is to be added to the protocol. See 225. If so, then 223 is repeated. In the case of a GUI, the displayed result of adding reactions to a particular protocol is depicted in FIG. 2H (note, as mentioned above, that some records have Markush representations, and some do not). If no more reactions are to be added, then the current protocol is completed and another decision is made as to whether or not another protocol is to be created in the record. See 227. If so, then 221 is repeated, along with 223 and 225 as many times as required. If not, then another decision is made as to whether or not any more single reactions (those not part of a synthetic sequence (protocol)) are to be entered into the record. See 231. If so, then a logical reaction is created from information received for the next chemical reaction in the current reference and the logical reaction is incorporated into the database. See 229. If not, then a decision is made as to whether or not any more records are to be characterized. See 233. If so then, the sequence 215-233 is repeated. If not then the procedure of populating the database is complete.

Referring back to decision block 219, if a reference does not contain any synthetic sequences for which a logical protocol is to be created, then sequence 229-233 is followed. In other words, any reactions disclosed in the current reference will have associated logical reactions created and incorporated into the database, without creating an associated logical protocol.

FIGS. 2B and 2C show in more detail examples of the processes of blocks 221 and 223 from FIG. 2A. These are the processes of creating a logical protocol and a logical reaction, and then incorporating these features into one or more records.

In FIG. 2B, showing a process flow of block 221 of FIG. 2A, the process begins with a decision 235, which determines whether or not protocol ontology information is to be included in the record for the current protocol. If so, then the appropriate protocol ontology information (as described above) is received and incorporated into the record. See 237. These two operations are optional, as not all databases of this invention employ a protocol level ontology.

Next, at 239, “points of interest” information is received and incorporated into the record. Points of interest are descriptive text, used to describe or characterize the current protocol. For example, a point of interest might point out the utility of the current protocol over conventional or similar protocols. If a user is reviewing filtered search data that includes a number of similar protocols, she might look to the associated points of interest for each of the protocols to help choose the best one to suit her needs. In another example, a point of interest might include safety information such as “reaction number three is not amenable to scale-up!” In this case, the user is informed that there may be personal safety issues if reaction number three of the protocol is carried out on a scale larger than that reported. Other examples of points of interest include, but are not limited to, reaction mechanism, molecule stability, reaction kinetics, alternative methods, alternative equipment, reactivity ranges for reactions of the protocol, reactions that were tried and did not work, protection group strategy used, and the like.

Referring back to FIG. 2B, once points of interest for the protocol have been incorporated into the record, then representative examples are received and incorporated into the record. See 241. Representative examples provide information about the protocol such as examples of the type of products produced by the protocol, or by particular reactions of the protocol. In general, representative examples are given to provide the user with a quick overview of the types (diversity) of reactions, reactants, products, procedures, and the like, that are used in the protocol. For example, if a particular reference has twenty protocols, then the user can look to the representative example fields of the data record (search results) for a single protocol of the reference to see what kinds of products were made across the twenty protocols, without having to manually look at all twenty. Once the representative examples have been incorporated into the record, the process flow of block 221 is complete.

At this point, the high level construction of a logical protocol has been completed. However, details about the individual reactions comprising the protocol have yet to be incorporated. This is the function of process 223. FIG. 2C presents one example of a process flow for implementing block 223 of FIG. 2A (for a single reaction). The process begins with a decision 243 in which it is determined whether or not the current reaction is to be classified within a reaction ontology. If so, then reaction ontology information (as described above) is received and incorporated into the record. See 245. Operations 243 and 245 are optional, as some embodiments of this invention will not employ a reaction level ontology.

Regardless of whether a reaction ontology is employed, structural representations of the current chemical transformation (reaction) are received and incorporated into the record. See 247. Next, reaction “procedure” information for the current reaction is received and incorporated into the current record. See 249. As indicated above, a procedure generally provides a detailed recipe for performing a chemical reaction. Next in the process, reaction conditions for the current reaction are received and incorporated into the record. See 251. Reaction conditions are a condensed set of details taken from the procedure for the reaction such as a brief summary of a procedure's salient steps. Thus reaction conditions may be used by a chemist to create a procedure by “filling in the gaps” with her knowledge of synthetic technique. In conventional databases, reaction conditions are commonly depicted as a non-searchable textual unit “over the arrow” in a structurally depicted chemical reaction. In this invention however, each reaction condition parameter is given a unique data field for subsequent searching and filtering. So the invention provides reaction conditions in a format similar to conventional databases in that the user can see them in one place in a data set, but goes further to allow searching and filtering by each of the data fields of the reaction conditions. Examples of reaction conditions are time, temperature, pressure, irradiation, and the like. In other words, reaction conditions specify what the reagents and reactants are exposed to in order to drive conversion of the reactants to products.

Then reagents (as defined above) used in the current reaction are received and incorporated into the current record. See 253. In one embodiment, the reagents are entered in particular formatted fields, including, for example, structure (graphic), chemical formula (text), name (text), and abbreviation (text). For example, if the catalyst 4-N, N-dimethylaminopyridine is used as a reagent in a reaction, then the information, 259, received and incorporated into the record would be represented as depicted in FIG. 2D.

After the reagents used in the current reaction are incorporated into the record, a determination (255) is made as to whether or not a Markush representation was used as the structural representation (in block 247). If a Markush was used, then the structure files corresponding to the Markush representation (created in block 209 of FIG. 2A) are uploaded into or otherwise linked to the current record. This may allow eventual enumeration (generating actual representations of each molecule in the reaction). Although in this particular embodiment structural files for the Markush representations were created early on in the process flow, when reference records were initially created (block 209, FIG. 2A), they may be created anywhere in the process flow. For example, they may be created after the operation of block 255 and before the operation of block 257. The order of many of the other operations within processes 201, 221, and 223 may be altered without significant consequence.

### Reference Information Filters

As mentioned above, a reference is represented at one level in a database record, so that each record is linked at some level to a reference and thus contains pertinent information about the reference. Reference information filters can be applied to define or narrow search queries. Such filters include author, journal (including title, volume, date), keywords, lead references, and reference-level ontology categorical hierarchies i.e. solid phase, solution phase, etc. as described in FIG. 1. Again, since databases are populated as described, reference information filters allow the user to quickly narrow a data set to that which is most pertinent to his needs. For example, by using reference information filters, a user may filter a set of records to give only those records pertaining to solid phase synthesis references by a particular author and published within a specified date range.

### Reaction Condition and Activity Filters

As mentioned, constraints on the range of reaction (process) conditions cannot be easily addressed using current chemical software available to a chemist. When reaction conditions need to be constrained due to a limitation of a synthesis apparatus or lability of a reagent or product in the synthesis, for example, reaction condition filters of the invention can provide chemical information pertaining to the user's unique process constraints. This feature can reduce or eliminate unnecessary methodology research. Further, using reaction condition filters together with chemical reaction data classified by type, the user can use the invention to design new libraries based on constraints particular to her parallel synthesis apparatus. For example, if a chemist knows that her apparatus can only perform reactions at room temperature and with no inert atmosphere, she can input these as reaction condition constraints. She can also input reactant or product constraints; for example the starting reagents being secondary amines. The chemist (user) inputs these constraints, and the invention provides a list of reactions (from the literature and generated by logic, vida supra) that can be performed with secondary amines at room temperature and without the need for an inert atmosphere. As well, the user may narrow the search further and filter by reaction yield, for example the invention provides a subset of the previous record list each reaction having a yield of 75% or better as stipulated by the user.

Also, the reactions can be sorted by type, so that the user need not manually sift through the list to find reactions of the same type. Her compound library can therefore consist of compounds synthesized using those reactions in the list provided by the invention or a chosen subset of the list. Also, since each of the reactions in the database has been typed, its constituent reactants and products have been tagged by type. This means that for each member of a particular reagent class, for example aldehydes, ketones, amines, etc., there is an annotation (tag) made in the database. Therefore the user can use the list of reactions to compile reagent tags in order to generate lists containing reagents of a particular class. This is important, because reagents are more conveniently used in library synthesis and stored, by class. For example, acid chlorides are often volatile, require refrigeration, and ventilation; more benign reagent sets can be stored under less stringent storage protocols. As well, the user can retrieve vendor information about each reactant or reagent and compile ordering lists for libraries designed by the invention.

Searching the reference records by reaction type for example can be done (as is done conventionally) by structure and substructure queries or filters. In addition the invention allows filtering by reaction type by textual input, because reactions are tagged according to type. Thus, a user may obtain specific reaction information without the need for structure-based queries.

The software tools of this invention may also include filters that require compounds to possess certain levels of activity. Pharmacophore analysis and SAR tools are examples of such tools. These tools may predict effectiveness based on binding with a target, for example. Other tools may be employed to predict ADMET (Adsorption, Distribution, Metabolism, Excretion, Toxicity) properties. Compounds proposed by one software tool are analyzed by one or more filtering tools that predict activity from structure. If the predicted activity of a proposed compound does not meet an activity threshold specified by a filter, then that compound may be rejected or given lower priority by the system.

One type of ADMET related filter may apply standard rules of thumb to select potential compounds. Typically, pharmaceutical companies seek orally available drugs because those are the most accepted by the public i.e. those drugs that can be formulated and administered in “pill” form. Before any compound can be considered as an orally available drug candidate, its pharmacokinetic profile must be determined. From available pharmacological data, a set of rules for determining bioavailability of compounds as a function of structural parameters has been formulated. These rules are known as the “Lipinski Rule of Five,” which generally relate bodily absorption of compounds through the gut wall to the compounds' molecular weight, number of heteroatoms, lipophilicity, and so on. These rules and other predictive structure-related pharmacological trends are used as an additional filter option to the user, giving yet another level of value in compound or compound library design. Not only does the user obtain synthesis data coupled with reliability data, but also the reliable chemistries can be filtered so that only pharmacologically relevant compounds are made. This saves valuable chemistry and pharmacology resources.

### Reliability Ratings

In a particular embodiment of the invention, chemical reactions and reactants are given reliability ratings. Based on known reliable chemical reaction data, peer-reviewed chemistry, and ongoing reliability testing, chemical reactions and reactants are catalogued with associated reliability data. These data form the basis for reliability ratings, ranking reactions based on reproducibility, range of suitable reaction conditions, yield, and the like.

As mentioned above, the invention can generate reaction examples based on literature precedent. Incorporation of reliability data into such algorithms provides the user with confidence margins that the proposed chemistries will work. In one example, the user can input an acceptable desired confidence level as a filter. The output of generated reactions would then include only those reactions with acceptable reliability ratings. All reactions are grouped not only by type, but also by source, that is, whether from literature example or generation via logic of the invention. Logically generated reaction data include reliability ratings that take into account extrapolated error probability factors. Probability factors for success in new reactions or existing reactions with new building blocks can then be compared with yields of known reactions and multiple reactions linked together in a sequential fashion.

Reliability ratings are not only important for the user as descriptors of chemical reactions as whole entities, but also as predictors for identifying reaction types available to the user for a particular starting reagent. For example, based on an initial query, the invention can suggest that a particular precursor or class of precursors can reliably undergo multiple types of reaction, that is, without actually retrieving or generating such reactions. The user can use this predictive information to tailor a subsequent query, more relevant to her library design plan, for example considering the reagents available to her at the time.

### Other Filters

Various other filters may be employed. In one example, a filter may limit a data set to those protocols having ten steps or less. In another example, a filter may limit records to only those specifying references in which parallel synthesis libraries of a certain size are made; e.g., references describing libraries containing one hundred or less members. Additional filters can look for similar reactions along a synthetic pathway from a particular functional group (i.e. all reactions from a secondary amine). Further filters can look for all library chemistry that afford a functional group say with a negative charge or with six atoms (plus or minus three) from an amide or other related structural constraints.

### Software/Hardware Generally

Generally, embodiments of the present invention employ various processes or methods involving data stored in or transferred through one or more computing devices. Embodiments of the present invention also relate to an apparatus for performing these operations. This apparatus may be specially constructed for the required purposes, or it may be a general-purpose device (e.g., a computer) selectively activated or reconfigured by instructions (e.g., a computer program) and/or data structure provided to the apparatus. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure generally representing a variety of these machines will be described below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium (including electronic or optically conductive pathways). Examples of program instructions include both machine code, such as produced by a compiler, and files containing higher level code that may be executed by the computer using an interpreter.

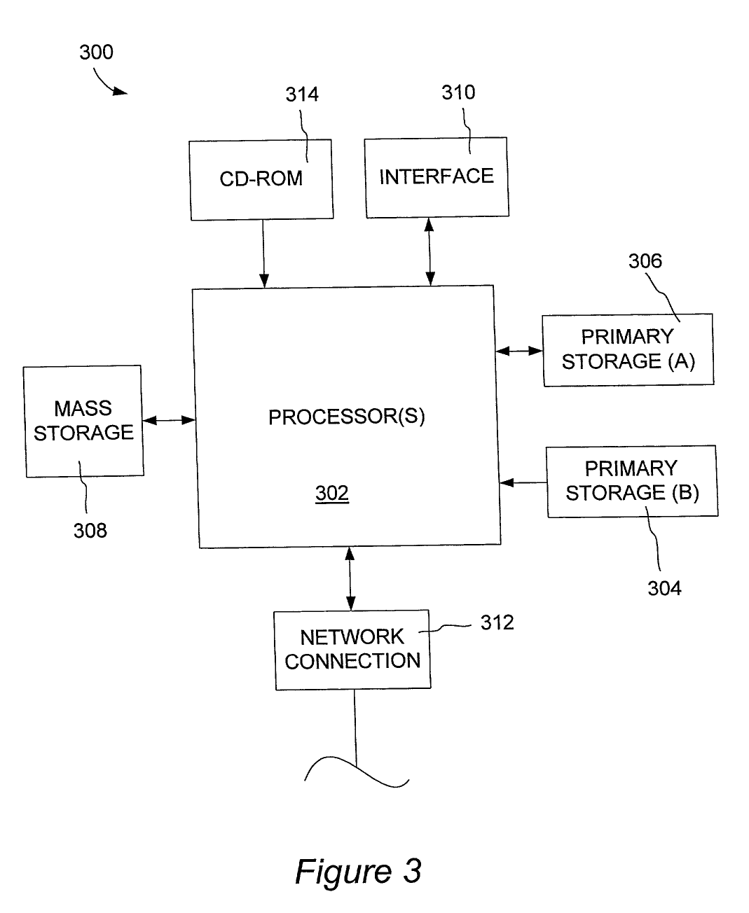

FIG. 3 illustrates, in simple block format, a typical computer system that, when appropriately configured or designed, can serve as an image analysis apparatus of this invention. The computer system 300 includes any number of processors 302 (also referred to as central processing units, or CPUs) that are coupled to storage devices including primary storage 306 (typically a random access memory, or RAM), primary storage 304 (typically a read only memory, or ROM). CPU 302 may be of various types including microcontrollers and microprocessors such as programmable devices (e.g., CPLDs and FPGAs) and unprogrammable devices such as gate array ASICs or general purpose microprocessors. As is well known in the art, primary storage 304 acts to transfer data and instructions uni-directionally to the CPU and primary storage 306 is used typically to transfer data and instructions in a bi-directional manner. Both of these primary storage devices may include any suitable computer-readable media such as those described above. A mass storage device 308 is also coupled bi-directionally to CPU 302 and provides additional data storage capacity and may include any of the computer-readable media described above. Mass storage device 308 may be used to store programs, data and the like and is typically a secondary storage medium such as a hard disk. It will be appreciated that the information retained within the mass storage device 308, may, in appropriate cases, be incorporated in standard fashion as part of primary storage 306 as virtual memory. A specific mass storage device such as a CD-ROM 314 may also pass data uni-directionally to the CPU.

CPU 302 is also coupled to an interface 310 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a database or a computer or telecommunications network using an external connection as shown generally at 312. With such a connection, it is contemplated that the CPU might receive information from the network, or might output information to the network in the course of performing the method steps described herein.

In one embodiment, the computer system 300 is configured as a database and database management system for chemical information organized as described herein. The chemical information may derive from various sources. Remote sources of chemical information may provide the information to system 300 via interface 312.

Once in the apparatus 300, a memory device such as primary storage 306 or mass storage 308 stores the chemical information. The memory may also store various routines and/or programs for analyzing and presenting the data. Such programs/routines may include database management systems, search engines, filtering programs (including QSAR programs, docking programs, ADMET/PK property prediction programs, etc.) programs for populating databases with new chemical information, tools for improving the performance of databases, etc.

Other Embodiments

While this invention has been described in terms of a few preferred embodiments, it should not be limited to the specifics presented above. Many variations on the above-described preferred embodiments may be employed. Therefore, the invention should be broadly interpreted with reference to the following claims.

What is claimed is:

1. A method of populating a database of chemical information, the method comprising:
(a) receiving a plurality of references containing chemical content meeting specified criteria; and
(b) for each reference identified in (a):
(i) entering descriptive information about the reference;
(ii) identifying one or more reaction steps specified in the reference; and
(iii) for each reaction step identified in (ii), entering a description of the procedure for performing the reaction.

2. The method of claim 1, further comprising entering structures of one or more of a reactant and a product of the reaction step.

3. The method of claim 1, further comprising for each reference identified in (a), identifying concepts that pertain to a chemical ontology and associating said reference with corresponding categories of the chemical ontology;

4. The method of claim 1, wherein the references include one or more of a literature article, a patent document, and unpublished experimental results.

5. The method of claim 1, wherein the references include publications.

6. The method of claim 1, wherein the specified criteria comprise disclosing an organic molecule synthesis.

7. The method of claim 1, wherein the specified criteria comprise disclosing syntheses of a library of organic molecules.

8. The method of claim 1, wherein the descriptive information comprises at least one of an author of the reference, an inventor of concepts within the reference, contact information for an author or inventor, and an abstract.

9. The method of claim 1, wherein the descriptive information is entered in specific fields corresponding to attributes in records of the database.

10. The method of claim 3, wherein the chemical ontology is defined at one or more of the following levels: a reference level, a protocol level, and a reaction level.

11. The method of claim 1, further comprising entering one or more leading references that comprise literature references or patent documents describing reactants discussed in the reference or work on which the reference is based.

12. The method of claim 1, further comprising entering a structure of a reagent or solvent used in the reaction step.

13. The method of claim 2, wherein the entered structures are provided in a standard chemical structural format.

14. A computer program product comprising a computer readable medium on which is provided program instructions for populating a database of chemical information, the program instructions specifying at the least the following actions:
(a) receiving a plurality of references containing chemical content meeting specified criteria; and
(b) for each reference identified in (a):
(i) entering descriptive information about the reference;
(ii) identifying one or more reaction steps specified in the reference; and
(iii) for each reaction step identified in (ii), entering a description of the procedure for performing the reaction.

15. The computer program product of claim 14, further comprising program instructions for entering structures of one or more of a reactant and a product of the reaction step.

16. The computer program product of claim 14, further comprising for each reference identified in (a), identifying concepts that pertain to a chemical ontology and associating said reference with corresponding categories of the chemical ontology;

17. The computer program product of claim 14, wherein the references include one or more of a literature article, a patent document, and unpublished experimental results.

18. The computer program product of claim 14, wherein the references include publications.

19. The computer program product of claim 14, wherein the specified criteria comprise disclosing an organic molecule synthesis.

20. The computer program product of claim 14, wherein the specified criteria comprise disclosing syntheses of a library of organic molecules.

21. The computer program product of claim 14, wherein the descriptive information comprises at least one of an author of the reference, an inventor of concepts within the reference, contact information for an author or inventor, and an abstract.

22. The computer program product of claim 14, wherein the descriptive information is entered in specific fields corresponding to attributes in records of the database.

23. The computer program product of claim 16, wherein the chemical ontology is defined at one or more of the following levels: a reference level, a protocol level, and a reaction level.

24. The computer program product of claim 14, further comprising program instructions for entering one or more leading references that comprise literature references or patent documents describing reactants discussed in the reference or work on which the reference is based.

25. The computer program product of claim 14, further comprising program instructions for entering a structure of a reagent or solvent used in the reaction step.

26. The computer program product of claim 15, wherein the entered structures are provided in a standard chemical structural format.

27. A method of populating a database of chemical information, the method comprising:
(a) receiving a plurality of references containing chemical content meeting specified criteria; and
(b) for each reference identified in (a):
(i) entering descriptive information about the reference;
(ii) identifying at least one protocol specified in the reference, which protocol comprises two or more reaction steps; and
(iii) specifying that the two or more reaction steps belong to said protocol in a manner that links the two or more reaction steps to one another within the protocol.

28. The method of claim 27, further comprising entering structures of one or more of a reactant and a product for each of the reaction steps.

29. The method of claim 27, further comprising for each reference identified in (a), identifying concepts that pertain to a chemical ontology and associating said reference with corresponding categories of the chemical ontology;

30. The method of claim 27, wherein the references include one or more of a literature article, a patent document, and unpublished experimental results.

31. The method of claim 27, wherein the references include publications.

32. The method of claim 27, wherein the specified criteria comprise disclosing an organic molecule synthesis.

33. The method of claim 27, wherein the specified criteria comprise disclosing syntheses of a library of organic molecules.

34. The method of claim 27, wherein the descriptive information comprises at least one of an author of the reference, an inventor of concepts within the reference, contact information for an author or inventor, and an abstract.

35. The method of claim 27, wherein the descriptive information is entered in specific fields corresponding to attributes in records of the database.

36. The method of claim 29, wherein the chemical ontology is defined at one or more of the following levels: a reference level, a protocol level, and a reaction level.

37. The method of claim 27, further comprising entering one or more leading references that comprise literature references or patent documents describing reactants discussed in the reference or work on which the reference is based.

38. The method of claim 27, further comprising entering a structure of a reagent or solvent used in each of the reaction steps.

39. The method of claim 28, wherein the entered structures are provided in a standard chemical structural format.

40. A computer program product comprising a computer readable medium on which is provided program instructions for populating a database of chemical information, the program instructions specifying at the least the following actions:
(a) receiving a plurality of references containing chemical content meeting specified criteria; and
(b) for each reference identified in (a):
(i) entering descriptive information about the reference;
(ii) identifying at least one protocol specified in the reference, which protocol comprises two or more reaction steps; and
(iii) specifying that the two or more reaction steps belong to said protocol in a manner that links the two or more reaction steps to one another within the protocol.

41. The computer program product of claim 40, further comprising program instructions for entering structures of one or more of a reactant and a product for each of the reaction steps.

42. The computer program product of claim 40, further comprising for each reference identified in (a), identifying concepts that pertain to a chemical ontology and associating said reference with corresponding categories of the chemical ontology;

43. The computer program product of claim 40, wherein the references include one or more of a literature article, a patent document, and unpublished experimental results.

44. The computer program product of claim 40, wherein the references include publications.

45. The computer program product of claim 40, wherein the specified criteria comprise disclosing an organic molecule synthesis.

46. The computer program product of claim 40, wherein the specified criteria comprise disclosing syntheses of a library of organic molecules.

47. The computer program product of claim 40, wherein the descriptive information comprises at least one of an author of the reference, an inventor of concepts within the reference, contact information for an author or inventor, and an abstract.

48. The computer program product of claim 40, wherein the descriptive information is entered in specific fields corresponding to attributes in records of the database.

49. The computer program product of claim 42, wherein the chemical ontology is defined at one or more of the following levels: a reference level, a protocol level, and a reaction level.

50. The computer program product of claim 40, further comprising program instructions for entering one or more leading references that comprise literature references or patent documents describing reactants discussed in the reference or work on which the reference is based.

51. The computer program product of claim 40, further comprising program instructions for entering a structure of a reagent or solvent used in each of the reaction steps.

52. The computer program product of claim 41, wherein the entered structures are provided in a standard chemical structural format.
